(19) United States
(12) Patent Application Publication
(10) Pub. No.: US 2025/0217297 A1
(43) Pub. Date: Jul. 3, 2025

(54) SYSTEMS AND METHODS FOR INDICATING RECENTLY INVALIDATED CACHE LINES

(71) Applicant: Advanced Micro Devices, Inc., Santa Clara, CA (US)

(72) Inventors: Amit P. Apte, Austin, TX (US); Ganesh Balakrishnan, Austin, TX (US)

(73) Assignee: Advanced Micro Devices, Inc., Santa Clara, CA (US)

(21) Appl. No.: 17/992,609

(22) Filed: Nov. 22, 2022

(51) Int. Cl. G06F 12/0891

(52) U.S. Cl. CPC G06F 12/0891

(57) ABSTRACT

A computing device includes detection circuitry configured to detect invalidation of a line of a cache array. The computing device additionally includes setting circuitry configured to set, in response to the detected invalidation, a spare state encoding in an entry of a partial line-based probe filter that indicates recent invalidation of the line of the cache array. The computing device also includes processing circuitry configured to process a transaction that hits on the entry of the partial line-based probe filter by avoiding a multicast probe of the cache array. Various other methods, systems, and computer-readable media are also disclosed.

### BACKGROUND

In a cache line-based directory scheme, each cache line is tracked individually. As a result, the size of the cache directory (i.e., probe filter(s)) has to increase linearly with the total capacity of all of the CPU cache subsystems in the computing system. The total CPU cache size tends to grow exponentially as memory technology improves. Accordingly, a line-based cache directory scheme has proven unable to keep up with the exponential growth of the CPU cache size. To address these issues, region-based probe filters can be used to track cache regions instead of, or in addition to, individual cache lines.

In a region-based probe filter, the granularity of tracking is coarse. The directory entry can have “sector valids” that are aggregate presence bits for a group of cache lines. However, without a sector valid bit per cache line in the region, it is difficult to know whether any central processing unit (CPU) caches have subscribed to a particular line in the sector. To address this problem, a partial (i.e., supporting) line-based probe filter can be used, and such partial line-based probe filters can be employed for communication lines.

Unlike the entries in the region-based probe filter, the entries in the line-based probe filter are expendable. As a result, while the absence of an address in the region-based probe filter can be taken as a guarantee that no CPU caches are subscribed to the line, the same is not true of a partial line-based probe filter. If an address has a partial line-based probe filter entry that is invalidated, that entry is typically reclaimed (i.e., removed) from the cache directory structure. As a result, subsequent accesses to the same line result in a multicast probe of the CPU caches using the information in the coarser region-based probe filter entry.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for indicating recently invalidated cache lines.

FIG. 2 is a block diagram of an additional example system for indicating recently invalidated cache lines.

FIG. 3 is a flow diagram of an example method for indicating recently invalidated cache lines.

FIG. 4 is a block diagram illustrating an example of a probe filter for indicating recently invalidated cache lines.

FIG. 5 is a graphical illustration of a region-based probe filter supported by a partial line-based probe filter for indicating recently invalidated cache lines.

FIG. 6 is a graphical illustration of a shared entry of a region-based probe filter supported by a partial line-based probe filter for indicating recently invalidated cache lines.

FIG. 7 is a graphical illustration of a nonshared entry of a region-based probe filter supported by a partial line-based probe filter for indicating recently invalidated cache lines.

FIG. 8 is a graphical illustration of a partial line-based probe filter for indicating recently invalidated cache lines of a set.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for indicating recently invalidated cache lines. As disclosed herein, a spare state encoding can be used to indicate recently invalidated lines in a partial line-based probe filter. Once created, these entries can persist until the set of entries runs out of empty entries for allocation. If a transaction hits on a known invalid state in the partial line-based probe filter, a multicast probe (e.g., broadcast probe) can be avoided. In some examples, an entry can transition to a valid state if an operation type allocates in the CPU caches (e.g., is a cacheable request). When a region-based probe filter entry is naturally reclaimed, the known invalid entries in the partial line-based probe filter can be reclaimed.

In one example, a computing device includes detection circuitry configured to detect invalidation of a line of a cache array, setting circuitry configured to set, in response to the detected invalidation, a spare state encoding in an entry of a partial line-based probe filter that indicates recent invalidation of the line of the cache array, and processing circuitry configured to process a transaction that hits on the entry of the partial line-based probe filter by avoiding a multicast probe of the cache array.

Another example can be the previously described computing device, wherein the detection circuitry is further configured to detect allocation of the line in the cache array based on an operation type corresponding to a cacheable request.

Another example can be the computing device of any of the previously described computing devices, wherein the setting circuitry is further configured to reset, in response to the detection of the allocation, the spare state encoding in the entry of the partial line-based probe filter in a manner that transitions the entry of the partial line-based probe filter to a valid state.

Another example can be the computing device of any of the previously described computing devices, wherein the detection circuitry is further configured to detect reclamation of a region-based probe filter.

Another example can be the computing device of any of the previously described computing devices, wherein the processing circuitry is further configured to reclaim, in response to the detection of the reclamation, the entry of the partial line-based probe filter.

Another example can be the computing device of any of the previously described computing devices, wherein the processing circuitry is further configured to reclaim, in response to the detection of the reclamation, entries of the partial line-based probe filter that support the region-based probe filter and that are marked as recently invalidated by setting of the spare state encoding.

Another example can be the computing device of any of the previously described computing devices, wherein the detection circuitry is further configured to detect that a set of entries of the partial line-based probe filter has run out of empty entries for allocation, and the processing circuitry is further configured to reclaim, at least partly in response to detecting that the set of entries of the partial line-based probe filter has run out of empty entries for allocation, an invalidated entry of the partial line-based probe filter of the set.

In one example, a system can include at least one physical processor and a physical memory comprising computer-executable instructions that, when executed by the physical processor, cause the physical processor to detect invalidation of a line of a cache array, set, in response to the detected invalidation, a spare state encoding in an entry of a partial line-based probe filter that indicates recent invalidation of the line of the cache array, and process a transaction that hits on the entry of the partial line-based probe filter by avoiding a multicast probe of the cache array.

Another example can be the system of the previously described example system, wherein the instructions further cause the physical processor to detect allocation of the line in the cache array based on an operation type corresponding to a cacheable request.

Another example can be the system of any of the previously described example systems, wherein the instructions further cause the physical processor to reset, in response to the detection of the allocation, the spare state encoding in the entry of the partial line-based probe filter in a manner that transitions the entry of the partial line-based probe filter to a valid state.

Another example can be the system of any of the previously described example systems, wherein the instructions further cause the physical processor to detect reclamation of a region-based probe filter.

Another example can be the system of any of the previously described example systems, wherein the instructions further cause the physical processor to reclaim, in response to the detection of the reclamation, the entry of the partial line-based probe filter.

Another example can be the system of any of the previously described example systems, wherein the instructions further cause the physical processor to reclaim, in response to the detection of the reclamation, entries of the partial line-based probe filter that support the region-based probe filter and that are marked as recently invalidated by setting of the spare state encoding.

Another example can be the system of any of the previously described example systems, wherein the instructions further cause the physical processor to detect that a set of entries of the partial line-based probe filter has run out of empty entries for allocation, and reclaim, at least partly in response to detecting that the set of entries of the partial line-based probe filter has run out of empty entries for allocation, an invalidated entry of the partial line-based probe filter of the set.

In one example, a computer-implemented method can include detecting, by at least one processor, invalidation of a line of a cache array, setting, by the at least one processor and in response to the detected invalidation, a spare state encoding in an entry of a partial line-based probe filter that indicates recent invalidation of the line of the cache array, and processing, by the at least one processor, a transaction that hits on the entry of the partial line-based probe filter by avoiding a multicast probe of the cache array.

In another example, the method of the previously described example method can further include detecting, by the at least one processor, allocation of the line in the cache array based on an operation type corresponding to a cacheable request.

Another example can be the method of any of the previously described example methods, further including resetting, by the at least one processor in response to the detection of the allocation, the spare state encoding in the entry of the partial line-based probe filter in a manner that transitions the entry of the partial line-based probe filter to a valid state.

Another example can be the method of any of the previously described example methods, further including detecting, by the at least one processor, reclamation of a region-based probe filter.

Another example can be the method of any of the previously described example methods, further including reclaiming, by the at least one processor in response to the detection of the reclamation, the entry of the partial line-based probe filter.

Another example can be the method of any of the previously described example methods, further including reclaiming, by the at least one processor in response to the detection of the reclamation, entries of the partial line-based probe filter that support the region-based probe filter and that are marked as recently invalidated by setting of the spare state encoding.

Another example can be the method of any of the previously described example methods, further including detecting, by the at least one processor, that a set of entries of the partial line-based probe filter has run out of empty entries for allocation, and reclaiming, by the at least one processor at least partly in response to detecting that the set of entries of the partial line-based probe filter has run out of empty entries for allocation, an invalidated entry of the set.

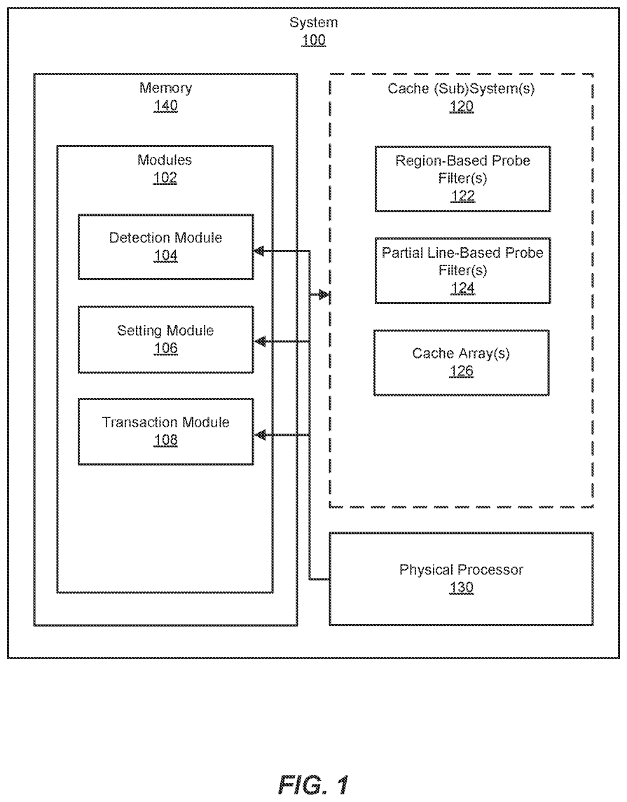

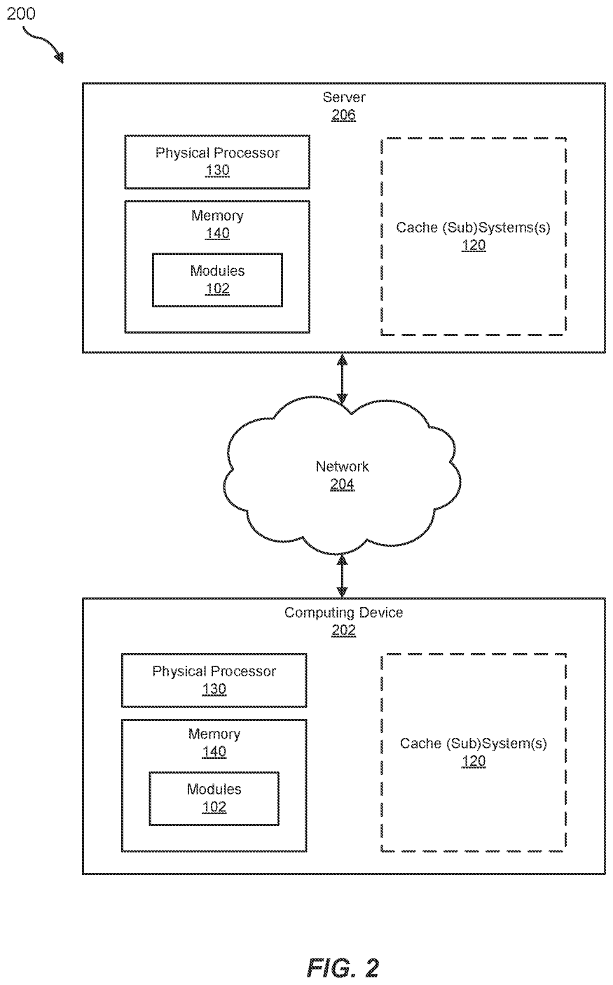

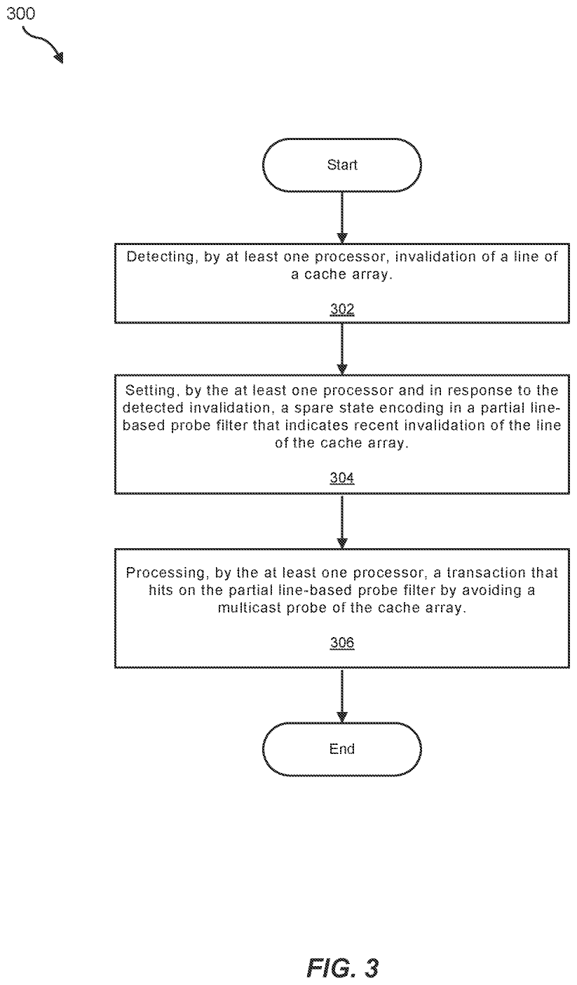

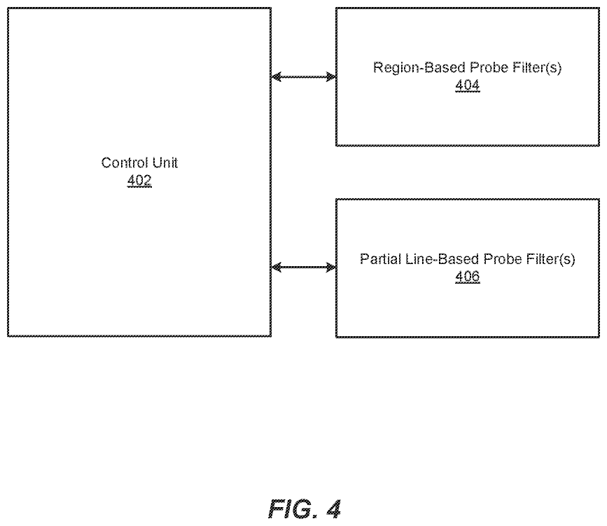

The following will provide, with reference to FIGS. 1-2, detailed descriptions of example systems for indicating recently invalidated cache lines. Detailed descriptions of corresponding computer-implemented methods will also be provided in connection with FIG. 3. In addition, detailed descriptions of example probe filters for indicating recently invalidated cache lines will be provided in connection with FIGS. 4-8.

FIG. 1 is a block diagram of an example system 100 for indicating recently invalidated cache lines. As illustrated in this figure, example system 100 can include one or more modules 102 for performing one or more tasks. As will be explained in greater detail below, modules 102 can include a detection module 104, a setting module 106, and a transaction module 108. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as the devices illustrated in FIG. 2 (e.g., computing device 202 and/or server 206). One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate indicating recently invalidated cache lines. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 1, example system 100 can also include one or more cache (sub) systems, such as cache (sub) system(s) 120. Cache (sub) system(s) 120 generally represents any type or form of high-speed data storage layer. In one example, cache (sub) system(s) 120 can store a subset of data, typically transient in nature, so that future requests for that data are served up faster than is possible by accessing the data's primary storage location. Examples of cache (sub) system(s) 120 include, without limitation, web caching (sub) systems, data caching (sub) systems, application/output caching (sub) systems, and distributed caching (sub) systems.

Example system 100 in FIG. 1 can be implemented in a variety of ways. For example, all or a portion of example system 100 can represent portions of example system 200 in FIG. 2. As shown in FIG. 2, system 200 can include a computing device 202 in communication with a server 206 via a network 204. In one example, all or a portion of the functionality of modules 102 can be performed by computing device 202, server 206, and/or any other suitable computing system. As will be described in greater detail below, one or more of modules 102 from FIG. 1 can, when executed by at least one processor of computing device 202 and/or server 206, enable computing device 202 and/or server 206 to indicate recently invalidated cache lines.

Computing device 202 generally represents any type or form of computing device having any circuitry capable of detecting and tracking invalidation. For example, computing device is any computer capable of receiving, processing, and storing data. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 206 generally represents any type or form of computing device that is capable of receiving, processing, and storing data. Additional examples of server 206 include, without limitation, storage servers, database servers, application servers, and/or web servers configured to run certain software applications and/or provide various storage, database, and/or web services. Although illustrated as a single entity in FIG. 2, server 206 can include and/or represent a plurality of servers that work and/or operate in conjunction with one another.

Network 204 generally represents any medium or architecture capable of facilitating communication or data transfer. In one example, network 204 can facilitate communication between computing device 202 and server 206. In this example, network 204 can facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1 and/or system 200 in FIG. 2. Conversely, all of the components and devices illustrated in FIGS. 1 and 2 need not be present to practice the implementations described and/or illustrated herein. The devices and subsystems referenced above can also be interconnected in different ways from that shown in FIG. 2. Systems 100 and 200 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 is a flow diagram of an example computer-implemented method 300 for indicating recently invalidated cache lines. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

As illustrated in FIG. 3, at step 302 one or more of the systems described herein can detect invalidation. For example, detection module 104 can, as part of computing device 202 in FIG. 2, detect, by at least one processor, invalidation of a line of a cache array.

The term “computer-implemented,” as used herein, generally refers to hardware, software, or any combination thereof. For example, and without limitation, computer-implemented can refer to specific hardware logic configured to detect and track invalidation. Alternatively, computer-implemented can refer to software configured to detect and track invalidation. Alternatively, computer-implemented can refer to a general-purpose processor in combination with software that configures the general-purpose processor to detect and track invalidation. Alternatively, computer-implemented can refer to a combination of a general-purpose processor, software, and specific hardware logic configured to detect and track invalidation.

The terms “processor” and “physical processor,” as used herein, generally refer to any circuitry capable of detecting and tracking invalidation. For example, and without limitation, processor and physical processor can refer to specific hardware logic configured to detect and track invalidation, a combination of a general-purpose processor that enacts machine-readable instructions, or combinations thereof.

The term “invalidation,” as used herein, generally refers to eviction of one or more cache lines from a cache (sub) system. For example, and without limitation, invalidation can include deleting an entry from an array, marking an entry as invalid in a manner that deallocates the entry, and/or any process or modification that prevents a probe filter entry from suppressing multicast probes. An implementation that marks entries as invalid in order to deallocate those entries is described in U.S. Pat. Pub. No. 2019/0188137, the disclosure of which is incorporated herein by reference in its entirety.

The term “line,” as used herein, generally refers to a chunk of memory handled by a cache. For example, and without limitation, a line can correspond to a distinct, nonoverlapping block of memory having a predetermined size (e.g., 16 to 256 bytes). Lines can be addressable according to an arrangement of memory and/or signaling elements in which the lines are configured.

The term “cache array,” as used herein, generally refers to hardware and/or software that is used to store something, usually data, temporarily in a computing environment. For example, and without limitation, a cache array can be fast access hardware such as random-access memory (RAM) and can also be used in correlation with a software component. A cache array can be implemented increase data retrieval performance by reducing the need to access an underlying slower storage layer.

The systems described herein can perform step 302 in a variety of ways. In some examples, detection module 104, as part of computing device 202 in FIG. 2, can detect invalidation of the line in response to a reference count for a shared region falling below a threshold and/or a region no longer being shared. Alternatively, detection module 104, as part of computing device 202 in FIG. 2, can receive a request (e.g., exclusive write access request, probe, etc.) and process a corresponding transaction that results in invalidation of the line of the cache array. Alternatively, detection module 104, as part of computing device 202 in FIG. 2, can receive a notification regarding processing of a transaction resulting in invalidation of the line of the cache array.

At step 304 one or more of the systems described herein can set one or more spare state encodings. For example, setting module 106 can, as part of computing device 202 in FIG. 2, set, by the at least one processor and in response to the detected invalidation, a spare state encoding in an entry of a partial line-based probe filter that indicates recent invalidation of the line of the cache array.

The term “spare state encoding,” as used herein, generally refers to any part of a probe filter entry that records nonessential data. For example, and without limitation, spare state encoding can include any field of an entry of a partial line-based probe filter that does not correspond to an address tag. In some examples, also without limitation, one or more bits of a line state field of an entry of a partial line-based probe filter can be spare state encodings that can be set (e.g., individually or in combination) to indicate recent invalidation.

The term “partial line-based probe filter,” as used herein, generally refers to a line-based cache directory that supports a region-based cache directory and has entries for less than all cache lines included in regions of the region-based cache directory. For example, and without limitation, a partial line-based probe filter can have one or more entries, individual ones of which record information about a line of a cache array. Additional details regarding partial line-based probe filters are provided in U.S. Pat. Pub. No. 2017/0177484, the disclosure of which is incorporated herein by reference in its entirety.

The term “entry,” as used herein, generally refers to an element of a data structure that records information about one or more lines of a cache array. For example, and without limitation, an entry can be an element of a data structure (e.g., vector, list, table, tree, etc.) that is region specific or line specific. Additionally, entries can have fields that record predetermined types of information about the one or more lines of the cache array.

The term “recent invalidation,” as used herein, generally refers to temporarily avoiding eviction of one or more invalid cache lines from a cache (sub) system. For example, and without limitation, recent invalidation can include marking an entry of a partial line-based probe filter in any manner that allows the entry to continue to suppress multicast probes and also be identifiable as a candidate for eviction (e.g., removal, deallocation, etc.) as needed.

The systems described herein can perform step 304 in a variety of ways. In some examples, setting module 106, as part of computing device 202 in FIG. 2, can write predetermined data to one or more spare state encodings of an entry of a partial line-based probe filter, wherein the entry has an address tag corresponding to an address of the invalidated cache line in a cache array. Alternatively, setting module 106, as part of computing device 202 in FIG. 2, can write predetermined data to a predetermined spare state encoding of an entry of a partial line-based probe filter, wherein the entry has an address tag corresponding to an address of the invalidated cache line in a cache array.

At step 306 one or more of the systems described herein can process a transaction. For example, transaction module 108 can, as part of computing device 202 in FIG. 2, process, by the at least one processor, a transaction that hits on the entry of the partial line-based probe filter by avoiding a multicast probe of the cache array.

The term “transaction,” as used herein, generally refers to access and/or management of one or more cache lines of a cache (sub) system. For example, and without limitation, example transactions can include a read access, a write access, a probe, etc.

The term “hit,” as used herein, generally refers to matching a request to an entry of a probe filter. For example, and without limitation, example hits can occur by matching one or more links in one or more requests (e.g., read, write, probe, etc.) to one or more address tags of one or more entries of a probe filter.

The term “hit,” as used herein, generally refers to a message to determine if one or more caches have a copy of a block of data. For example, and without limitation, a probe can be a message passed from a coherency point in a computer system to one or more caches in the computer system to determine if the caches have a copy of a block of data and optionally to indicate the state into which the cache should place the block of data. In this context, a multicast probe can be a probe transmitted to more than one of the CPU caches in the computing system. In this context, a broadcast probe can refer to a type of multicast probe transmitted to all CPU caches in the computing system.

The term “avoiding a multicast probe,” as used herein, generally refers to suppressing a multicast probe. For example, and without limitation, a multicast probe can be avoided by refraining from issuing and/or preventing transmission of a multicast probe in response to a hit on an entry of a probe filter.

The systems described herein can perform step 306 in a variety of ways. In some examples, transaction module 108, as part of computing device 202 in FIG. 2, can search entries of a region-based probe filter and observe that a reference (e.g., link) in a received request (e.g., read request, access request, read only access request, probe request, etc.) matches an address that falls within a range of addresses stored in a “sector valids” field of an entry of the region-based probe filter. In parallel, transaction module 108, as part of computing device 202 in FIG. 2, can search entries of a partial line-based probe filter supporting the region-based probe filter. Upon observing that an entry of the partial line-based probe filter has an address tag matching the references address, transaction module 108, as part of computing device 202 in FIG. 2, can avoid a multicast probe of the CPU caches.

In some examples, step 306 can include one or more additional operations. For example, transaction module 108, as part of computing device 202 in FIG. 2, can detect, by the at least one processor, allocation of the line in the cache array based on an operation type corresponding to a cacheable request. In some implementations of these examples, transaction module 108, as part of computing device 202 in FIG. 2, can reset, by the at least one processor in response to the detection of the allocation, the spare state encoding in the entry of the partial line-based probe filter in a manner that transitions the entry of the partial line-based probe filter to a valid state.

In additional or alternative examples, transaction module 108, as part of computing device 202 in FIG. 2, can detect, by the at least one processor, reclamation of a region-based probe filter. In some implementations of these examples, transaction module 108, as part of computing device 202 in FIG. 2, can reclaim, by the at least one processor in response to the detection of the reclamation, the entry of the partial line-based probe filter. In other implementations of these examples, transaction module 108, as part of computing device 202 in FIG. 2, can reclaim, by the at least one processor and in response to the detection of the reclamation, entries of the partial line-based probe filter that support the region-based probe filter and that are marked as recently invalidated by setting of the spare state encoding.

In additional or alternative examples, transaction module 108, as part of computing device 202 in FIG. 2, can detect, by the at least one processor, that a set of entries of the partial line-based probe filter has run out of empty entries for allocation, and reclaim, by the at least one processor at least partly in response to detecting that the set of entries of the partial line-based probe filter has run out of empty entries for allocation, a recently invalidated entry of the set. In some of these implementations, transaction module 108, as part of computing device 202 in FIG. 2, can read one or more state encodings of the entry. Upon observing that a spare state encoding has the predetermined data written to a state encoding of the entry, transaction module 108, as part of computing device 202 in FIG. 2, can reclaim the entry.

FIG. 4 illustrates an example of a probe filter (i.e., cache directory) for indicating recently invalidated cache lines. In some implementations, probe filter 400 includes at least control unit 402 coupled to region-based probe filter 404 and partial line-based probe filter 406. Region-based probe filter 404 includes entries to track cached data on a region-basis. In some implementations, individual entries of region-based probe filter 404 can include a reference count to count the number of accesses to cache lines of the region that are cached by the cache subsystems of the computing system (e.g., system 100 of FIG. 1). In one embodiment, when the reference count for a given region reaches a threshold, the given region will start being tracked on a line-basis by partial line-based probe filter 406.

Accordingly, in one embodiment, when the number of cache lines that are cached for a given region reaches a threshold, partial line-based probe filter 406 can start to track the accesses to individual lines of the given region. Each time a new cache line is accessed from the given region, a new entry is created in partial line-based probe filter 406 for the cache line. In some implementations, lookups can be performed in parallel to region-based probe filter 404 and partial line-based probe filter 406.

In some implementations, only shared regions that have a reference count greater than a threshold are tracked on a cache line-basis by partial line-based probe filter 406. A shared region refers to a region that has cache lines stored in cache subsystems of at least two different CPUs. A private region refers to a region that has cache lines that are cached by only a single CPU. Accordingly, in some implementations, for shared regions that have a reference count greater than a threshold, there will be one or more entries in the partial line-based probe filter 406. In such implementations, for private regions, there can be no entries in the partial line-based probe filter 406.

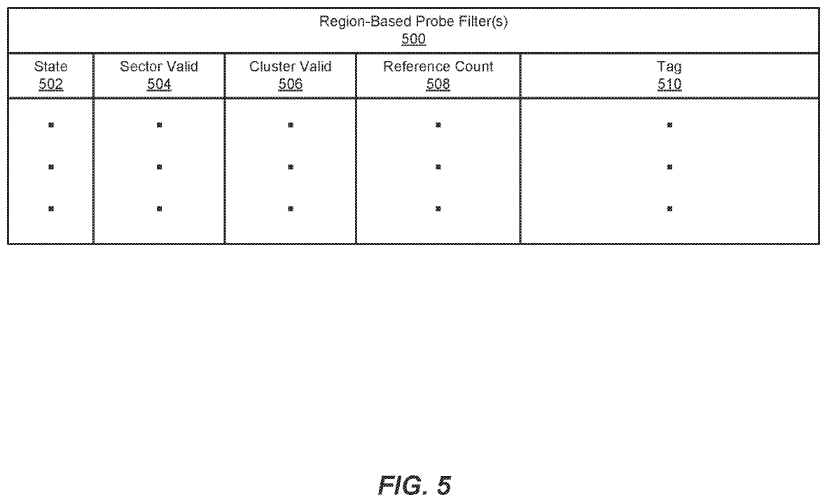

FIG. 5 is a graphical illustration of a region-based probe filter supported by a partial line-based probe filter for indicating recently invalidated cache lines. In some implementations, region-based probe filter 500 can include any number of entries, with the number of entries varying according to the implementation. In some implementations, individual entries of region-based probe filter 500 can include a state field 502, sector valid field 504, cluster valid field 506, reference count field 508, and tag field 510. In other implementations, the entries of region-based probe filter 500 can include other fields and/or can be arranged in other suitable manners.

The state field 502 can include state bits that specify the aggregate state of the region. The aggregate state is a reflection of the most restrictive cache line state for this particular region. For example, the state for a given region is stored as “dirty” even if only a single cache line for the entire given region is dirty. Also, the state for a given region is stored as “shared” even if only a single cache line of the entire given region is shared.

The sector valid field 504 can store a bit vector corresponding to sub-groups or sectors of lines within the region to provide fine grained tracking. By tracking sub-groups of lines within the region, the number of unwanted regular coherency probes and individual line probes generated while unrolling a region invalidation probe can be reduced. As used herein, a “region invalidation probe” is defined as a probe generated by the cache directory in response to a region entry being evicted from the cache directory. When a coherent master receives a region invalidation probe, the coherent master can invalidate each cache line of the region that is cached by the local CPU. Additionally, tracker and sector valid bits can be included in the region invalidation probes to reduce probe amplification at the CPU caches.

The organization of sub-groups and the number of bits in sector valid field 504 can vary according to various implementations. In some implementations, two lines can be tracked within a particular region entry using sector valid field 504. In other implementations, other numbers of lines can be tracked within each region entry. In some embodiments, sector valid field 504 can be used to indicate the number of partitions that are being individually tracked within the region. Additionally, the partitions can be identified using offsets which are stored in sector valid field 504. Each offset can identify the location of the given partition within the given region. Sector valid field 504, or another field of the entry, can also indicate separate owners and separate states for each partition within the given region.

The cluster valid field 506 can include a bit vector to track the presence of the region across various CPU cache clusters. For example, in some implementations, CPUs can be grouped together into clusters of CPUs. The bit vector stored in cluster valid field 506 can be used to reduce probe destinations for regular coherency probes and region invalidation probes.

The reference count field 508 can be used to track the number of cache lines of the region which are cached somewhere in the system. On the first access to a region, an entry can be installed in region-based probe filter 500 and the reference count field 508 can be set to one. Over time, each time a cache accesses a cache line from this region, the reference count can be incremented. As cache lines from this region are evicted by the caches, the reference count can decrement. Eventually, if the reference count reaches zero, the entry can be marked as invalid and the entry can be reused for another region. By utilizing the reference count field 508, the incidence of region invalidation probes can be reduced. The reference count field 508 allows directory entries to be reclaimed when an entry is associated with a region with no active subscribers. In some implementations, the reference count field 508 can saturate once the reference count crosses a threshold. The threshold can be set to a value large enough to handle private access patterns while sacrificing some accuracy when handling widely shared access patterns for communication data. The tag field 510 can include the tag bits that are used to identify the entry associated with a particular region.

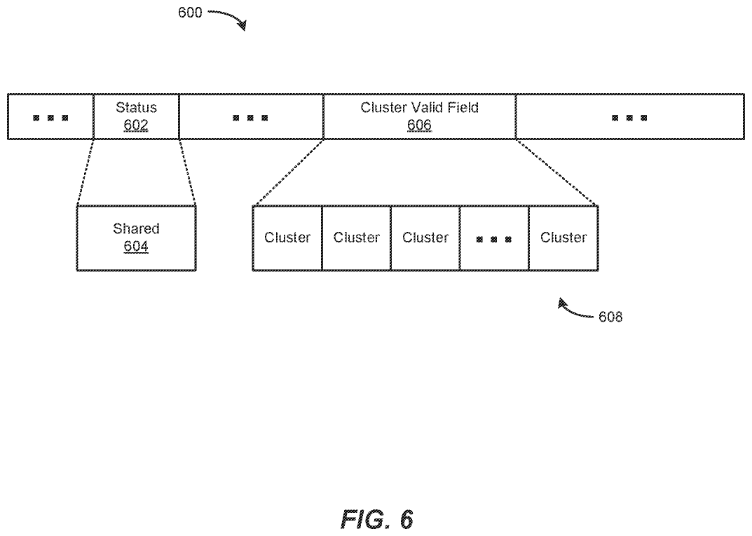

FIG. 6 is a graphical illustration of a shared entry of a region-based probe filter supported by a partial line-based probe filter for indicating recently invalidated cache lines. In some implementations, entry 600 includes various fields associated with a shared region being tracked by a cache directory. The status field 602 stores a shared encoding 604 to indicate that the corresponding region is shared. As used herein, a “shared” region refers to a region which has cache lines that are cached by multiple different CPU clusters. When the status field 602 stores a shared encoding 604, the cluster valid field 606 can store a bit vector to indicate which CPU clusters 608 are caching a cache line of the corresponding region. In this example, the cluster valid field 606 can group CPUs together into clusters. In some implementations, if a cluster bit is set to one, then this value can indicate that the cluster of CPUs stores at least one cache line from the region. Otherwise, if a cluster bit is set to zero, then this value can indicate that none of the CPUs in the cluster stores a cache line from the region. Entry 600 can also include any number of other fields which are not shown to avoid obscuring the figure.

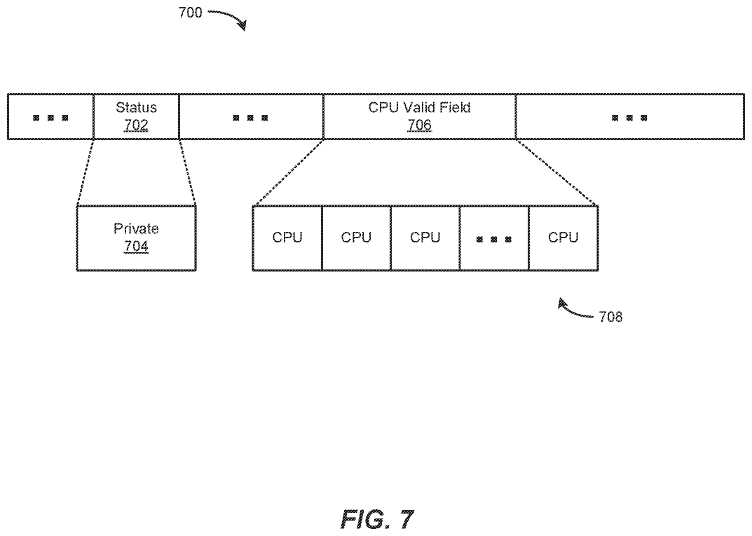

FIG. 7 is a graphical illustration of a non-shared entry of a region-based probe filter entry supported by a partial line-based probe filter for indicating recently invalidated cache lines. If the cluster valid field 606 (FIG. 6) were to remain unchanged even for a private region, a probe would need to be sent to all of the CPUs in the cluster that is identified as caching at least one cache line of that region. Rather, in some implementations, if a region is private (i.e., accessed by only a single cluster), then the cluster valid field can be repurposed into an owner valid field or CPU valid field. This repurposing allows the cache directory to probe one particular CPU for a private region.

Accordingly, if the region being tracked by entry 600 (FIG. 6) transitions from being a shared region to being a private region, then the entry 700 represents the change in fields as compared to entry 600 (FIG. 6) for this private region. As shown in entry 700, status 702 now includes a private 704 encoding to represent the private status of the region. Since the status 702 has now changed to private 704, the previous cluster valid field 606 (FIG. 6) now becomes CPU valid field 706. Each CPU bit 708 of the bit vector stored in CPU valid field 706 represents a single CPU of the original cluster. If a given CPU of this cluster caches at least one cache line of the corresponding region, then the particular CPU bit 708 can be set to one. Otherwise, if a given CPU of the cluster does not cache any cache lines from the region, then the corresponding CPU bit 708 can be set to zero.

By changing the cluster valid field 606 (FIG. 6) to CPU valid field 706, a directed probe can be sent out which is targeted to only the CPUs which have a cache line from the region. This targeting helps to reduce the number of unnecessary probes generated by the cache directory. In some implementations, if a request targeting the private region (corresponding to entry 700) is received from a different cluster, then this private region can become a shared region. When this happens, the cluster valid field 606 can be restored to its normal operation since the region is now shared.

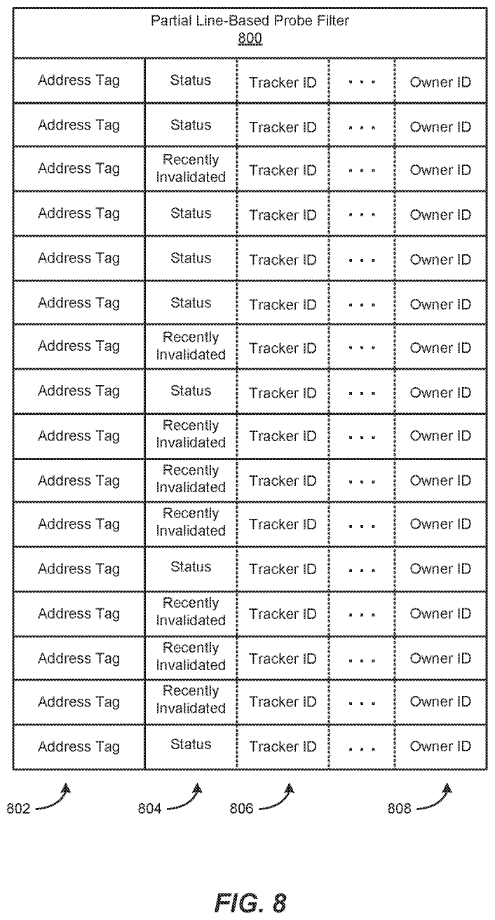

FIG. 8 is a graphical illustration of a partial line-based probe filter for indicating recently invalidated cache lines of a set (e.g., in a same region, in a same range of addresses, etc.). The partial line-based probe filter 800 stores entries for lines that are shared and that have a reference count above a threshold (e.g., 2, 3, etc.). These characteristics are common to widely shared access patterns for communication data, and thus these entries are for lines that tend to correspond to communication lines that can result in a significant number of multicast probes in the absence of the partial line-based probe filters that are used to avoid such probes. Individual entries of the partial line-based probe filter are typically reclaimed when they become invalid as a result of no longer being shared or if the reference count falls below the threshold, resulting in multicast probes for those lines. However, the present disclosure provides techniques that prevent immediate reclamation for recently invalidated entries of the partial line-based probe filter 800, and that mark those entries as invalid so that they can be reclaimed and/or made valid under certain conditions, as previously described with reference to FIG. 3. As a result, multicast probes can still be avoided for hits on recently invalidated entries of the partial line-based probe filter 800 and the invalid entries can still be reclaimed and made valid as needed.

In some implementations, individual entries of the partial line-based probe filter 800 can have various fields, including an address tag 802 and one or more state encodings. Address tag 802 can record all or part (e.g., most significant bits) of a cache line that corresponds to the entry. Example fields for valid entries can include a remote socket valid field, a local die valid field, an owner field 808, a line state field 804, and/or a tracker ID field 806. The remote socket valid field can be a bit vector that indicates that a remote socket (i.e., processing node) can have a cached copy of the cache line, and the local die valid field can be a bit vector that indicates nodes on a local socket can have a cached copy of the cache line. The line state field can indicate a state of the cache line, such as whether the entry is: invalid; exclusively owned; modified by an owner; clean and there is a single copy in the system; clean and forwarded with multiple copies in the system; shared but there is only a single copy in the system; shared and there are multiple copies in the system; and/or modified (dirty) by the owner and there are multiple copies in the system.

The line state field 804 can have dedicated bits for recording the above-described states and/or numerous, predefined bit combinations for recording these states. As a result, bit combinations can exist within line state field 804 that are not used during normal operation. For example, in the case of dedicated bits, some bit combinations can indicate two or more states that are mutually exclusive and, thus, would not occur simultaneously (e.g., owned but not modified, both clean and modified, both exclusively owned and shared, both single copy and multiple copies, etc.). Likewise, in the case of predefined bit combinations, there can be other bit combinations that are not predefined. These spare state encodings can be used to indicate that the entry is recently invalidated by defining a bit combination for this state. In some implementations, example bit combinations can include, without limitation, bit combinations that avoid setting a dedicated invalid bit to indicate that the entry is invalid, and that set two or more other dedicated bits to states that conflict with one another. By avoiding setting a dedicated invalid bit to invalid, the entry still can prevent multicast probes. By setting the two or more other dedicated bits to conflicting states, the recently invalid state of the entry can be recognized so that the entry still can be reclaimed and/or reset as described herein. In other implementations, the systems and methods described herein can be configured to respond differently to setting of a dedicated invalid bit or predefined bit combination by avoiding multicast probes and reclaiming and/or resetting the entry as described herein. In these implementations, the dedicated invalid bit and/or predefined bit combination is converted into a spare state encoding, as the dedicated invalid bit and/or predefined bit combination is no longer used in the normal way. In still other implementations, these principles may be applied in other entry fields by, for example, setting a tracker ID field 806, an owner ID field 808, or any other field (e.g., remote socket valid field, local die set field, etc.) to null or any out-of-range value.

Partial line-based probe filter 800 can comprise any suitable structure. For example, partial line-based probe filter 800 can be a fully associative memory in which any entry can be used for any block address. Partial line-based probe filter 800 can be operated on a first in first out (FIFO) basis in which the oldest entry is deleted when a new entry is added. Alternatively, partial line-based probe filter 800 can be operated as a modified FIFO in which invalid entries are filled before discarding the oldest valid entry. In another alternative, partial line-based probe filter 800 can use least recently used (LRU) replacement to replace entries. Other implementations can use any other replacement algorithm. Partial line-based probe filter 800 can alternatively or additionally be a set associative or direct mapped probe filter in which the block address can be used as an index to select an eligible entry or entries corresponding to a block address.

As set forth above, when a cache line associated by an entry is invalidated, one or more of the state encodings thereof can be considered spare state encodings because the information recorded therein is no longer needed. One or more of these spare state encodings can be used to record that the entry is recently invalidated, and removal and/or deallocation of the invalid entry from the partial line-based probe filter 800 can be avoided. As a result, a hit on the entry can still suppress a multicast probe, whereas removal of the entry would prevent such a hit from occurring, thus resulting in a multicast probe. The recordation of the recently invalidated state of the entries allows for one or more of these entries (e.g., selected at random or according to a predetermined methodology) to be reclaimed when the partial line-based probe filter runs out of empty entries.

The systems and methods disclosed herein use a spare state encoding to indicate recently invalidated lines in a partial line-based probe filter. Once created, these entries persist until the set of entries runs out of empty entries for allocation. If a transaction hits on a known invalid state in the partial line-based probe filter, a broadcast probe can be avoided and the entry can transition to a valid state if an operation type allocates in the CPU caches (e.g., is a cacheable request). When a region probe filter entry is naturally reclaimed, the known invalid entries in the partial line-based probe filter can be removed.

The disclosed techniques allow for performance of a broadcast probe to be avoided when a transaction hits on a known invalid state in the partial line-based probe filter. Use of a spare state encoding in the partial line-based probe filter provides this capability without consuming additional memory. As a result, the disclosed techniques improve latency by decreasing consumption of computational resources, and this improvement is realized without increasing consumption of hardware resources.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computing device, comprising:
at least one circuit configured to:
set, in response to detecting invalidation of a line of a cache array, a spare state encoding in an entry of a partial line-based probe filter, the spare state encoding indicating a recent invalidation of the line of the cache array; and
process a transaction that hits on the entry of the partial line-based probe filter having the spare state encoding indicating recent invalidation, the hit avoiding a multicast probe of the cache array.

2. The computing device of claim 1, wherein the at least one circuit is further configured to detect allocation of the line in the cache array based on an operation type corresponding to a cacheable request.

3. The computing device of claim 2, wherein the at least one circuit is further configured to reset, in response to the detection of the allocation, the spare state encoding in the entry of the partial line-based probe filter in a manner that transitions the entry of the partial line-based probe filter to a valid state.

4. The computing device of claim 1, wherein the at least one circuit is further configured to detect reclamation of a region-based probe filter.

5. The computing device of claim 4, wherein the at least one circuit is further configured to reclaim, in response to the detection of the reclamation, the entry of the partial line-based probe filter.

6. The computing device of claim 4, wherein the processing at least one circuit is further configured to reclaim, in response to the detection of the reclamation, entries of the partial line-based probe filter that support the region-based probe filter and that are marked as recently invalidated by setting of the spare state encoding.

7. The computing device of claim 1, wherein the at least one circuit is further configured to;
detect that a set of entries of the partial line-based probe filter has run out of empty entries for allocation; and
reclaim, at least partly in response to detecting that the set of entries of the partial line-based probe filter has run out of empty entries for allocation, an invalidated entry of the partial line-based probe filter of the set.

8. A system comprising:
at least one physical processor; and
physical memory comprising computer-executable instructions that, when executed by the at least one physical processor, cause the at least one physical processor to:
set, in response to detecting invalidation of a line of a cache array, a spare state encoding in an entry of a partial line-based probe filter, the spare state encoding indicating a recent invalidation of the line of the cache array; and
process a transaction that hits on the entry of the partial line-based probe filter having the spare state encoding indicating recent invalidation, the hit by avoiding a multicast probe of the cache array.

9. The system of claim 8, wherein the instructions further cause the at least one physical processor to:
detect allocation of the line in the cache array based on an operation type corresponding to a cacheable request.

10. The system of claim 9, wherein the instructions further cause the at least one physical processor to:
reset, in response to the detection of the allocation, the spare state encoding in the entry of the partial line-based probe filter in a manner that transitions the entry of the partial line-based probe filter to a valid state.

11. The system of claim 8, wherein the instructions further cause the at least one physical processor to:
detect reclamation of a region-based probe filter.

12. The system of claim 11, wherein the instructions further cause the at least one physical processor to:
reclaim, in response to the detection of the reclamation, the entry of the partial line-based probe filter.

13. The system of claim 11, wherein the instructions further cause the at least one physical processor to:
reclaim, in response to the detection of the reclamation, entries of the partial line-based probe filter that support the region-based probe filter and that are marked as recently invalidated by setting of the spare state encoding.

14. The system of claim 8, wherein the instructions further cause the at least one physical processor to:
detect that a set of entries of the partial line-based probe filter has run out of empty entries for allocation; and
reclaim, at least partly in response to detecting that the set of entries of the partial line-based probe filter has run out of empty entries for allocation, an invalidated entry of the partial line-based probe filter of the set.

15. A computer-implemented method comprising:
setting, in response to detecting invalidation of a line of a cache array, by at least one processor and in response to the detected invalidation, a spare state encoding in an entry of a partial line-based probe filter, the spare state encoding indicating a recent invalidation of the line of the cache array; and
processing, by the at least one processor, a transaction that hits on the entry of the partial line-based probe filter having the spare state encoding indicating recent invalidation, the hit avoiding a multicast probe of the cache array.

16. The method of claim 15, further comprising:
detecting, by the at least one processor, allocation of the line in the cache array based on an operation type corresponding to a cacheable request.

17. The method of claim 16, further comprising:
resetting, by the at least one processor in response to the detection of the allocation, the spare state encoding in the entry of the partial line-based probe filter in a manner that transitions the entry of the partial line-based probe filter to a valid state.

18. The method of claim 15, further comprising:
detecting, by the at least one processor, reclamation of a region-based probe filter.

19. The method of claim 18, further comprising:
reclaiming, by the at least one processor in response to the detection of the reclamation, the entry of the partial line-based probe filter.

20. The method of claim 18, further comprising:
reclaiming, by the at least one processor and in response to the detection of the reclamation, entries of the partial line-based probe filter that support the region-based probe filter and that are marked as recently invalidated by setting of the spare state encoding.
